(19) United States
(12) Patent Application Publication
(10) Pub. No.: US 2026/0280813 A1
(43) Pub. Date: Sep. 17, 2026

(54) SYSTEMS, APPARATUSES, METHODS, AND NON-TRANSITORY COMPUTER-READABLE STORAGE MEDIA FOR WIRELESS COMMUNICATIONS EMPLOYING MULTI-LINK OPERATION WITH LINK ADAPTATION

(71) Applicant: HUAWEI TECHNOLOGIES CO., LTD., Shenzhen (CN)

(72) Inventors: Mahmoud Hasabelnaby, Kelowna (CA); Osama Aboul-Magd, Kanata (CA); Jung Hoon Suh, Kanata (CA); Yan Xin, Kanata (CA); Sara Norouzi, Vancouver (CA); Abdalla Mohamed Abdelaziz Mahmoud Hussein, Ottawa (CA)

(21) Appl. No.: 19/363,290

(22) Filed: Oct. 20, 2025

Related U.S. Application Data
(60) Provisional application No. 63/773,086, filed on Mar. 17, 2025.

(51) Int. Cl. H04L 5/00; H04B 17/309; H04L 1/00; H04L 1/1607

(52) U.S. Cl. CPC H04L 5/0053; H04B 17/346; H04L 1/0003; H04L 1/1614

(57) ABSTRACT

A communication method performed by a first multi-link device (MLD), the method has the steps of: transmitting or receiving a first frame indicating a plurality of communication parameters of a plurality of links; and receiving or transmitting a plurality of data frames via the plurality of links using the plurality of communication parameters.

### CROSS-REFERENCE TO RELATED APPLICATION

This application claims the benefit of U.S. Provisional Patent Application Ser. No. 63/773,086, filed Mar. 17, 2025, the content of which is incorporated herein by reference in its entirety.

### TECHNICAL FIELD

The present disclosure relates generally to communication systems, apparatuses, methods, and non-transitory computer-readable storage devices, and in particular, to systems, apparatuses, methods, and non-transitory computer-readable storage devices for wireless communication employing multi-link operation with link adaptation.

### BACKGROUND

One of the most transformative features introduced in IEEE 802.11be (WI-FI® 7) is Multi-Link Operation (MLO), which allows devices to operate on multiple frequency bands and channels simultaneously. This capability promises to improve network performance by increasing throughput, reducing latency, and enhancing reliability, particularly in challenging environments with high interference or congestion.

In tandem with these advancements, the IEEE 802.11bn standard (WI-FI® 8) and IEEE 802.11bq standard (Integrated Millimeter waves) have been evolving to address the growing demand for more efficient and adaptive network management, especially in scenarios where WI-FI® devices may need to update their transmission parameters to enhance its reliability, to balance performance with power consumption, or when becoming temporarily unavailable due to participation in other non-WI-FI activities, such as those related to Bluetooth or Global Positioning System (GPS). One such area of focus is the enhancement of link adaptation, power-saving mechanisms, and the management of dynamic unavailability in devices, which are important for optimizing both power consumption and transmission reliability in real-world applications.

### SUMMARY

The present disclosure provides communication methods and apparatuses.

According to a first aspect, a non-AP STA MLD, one or more non-AP STAs affiliated therewith, receives, from an AP MLD, a request frame (also referred to as a second frame in the present disclosure) for obtaining adaptation parameters of one or more links between the non-AP STA MLD and the AP MLD; and transmits a response frame (also referred to as a first frame in the present disclosure) to the AP MLD, the response frame including a first field indicative of an adaptation parameter of at least one link among the one or more links.

According to some implementations, the non-AP STA MLD transmits a frame including a first field indicative of an unsolicited adaptation parameter of at least one link among the one or more links and a second field indicative of an acknowledgment of successful reception of PPDUs.

In some implementations, the first field includes a Per Associated Identifier (AID) Traffic Identifier (TID) information field, and the Per AID TID information field is used for indicating the first field to include the adaptation parameter of the at least one link.

In some implementations, the Per-AID TID information field includes: an AID11 field, an acknowledge (ACK) type field, and a TID field, wherein the AID11 field is indicative of an associated identifier of the STA; and the ACK type field and the TID field are used together for indicating the first field to include the adaptation parameter of the at least one link.

In some implementations, the first field includes: a Block ACK Starting Sequence Control field including: a field for indicating that a type of feedback is multi-link feedback; and a field for indicating that a sub-type of feedback is adaptation parameters of a plurality of links between the AP and the STA; and a Block ACK bitmap field including: a field indicative of an identifier of each link of the at least one link; and a field indicative of an adaptation parameter of each link of the at least one link.

In some implementations, the first field includes: a Block ACK Starting Sequence Control field including: a field for indicating that a type of feedback is adaptation parameters of a plurality of links between the AP and the STA; and a Block ACK bitmap field including: a field indicative of an identifier of each link of the at least one link; and a field indicative of an adaptation parameter of each link of the at least one link.

In some implementations, the field indicative of the link adaptation parameter includes at least one of: a length field indicative of a length of information related to an identifier of the link; a field indicative of modulation and coding scheme (MCS) of each link (such as MCS of each link under the next-generation IEEE 802.11 or ultra-high reliability (UHR) standard); a field indicative of equal or unequal modulation (EQM/UNEQM) flag of each link; a field indicative of unequal modulation (UNEQM) pattern of each link; a field indicative of number of spatial streams (NSS) of each link; a field indicative of signal-to-interference-and-noise-ratio (SINR) of each link; a field indicative of received signal strength indicator (RSSI) of each link; a field indicative of target receive power of each link; a field indicative of distributed resource unit (DRU)/regular resource unit (RRU) information of each link, and/or the like.

In some implementations, the field indicative of the millimeter wave link adaptation parameter includes at least one of: a length field indicative of a length of information related to an identifier of the millimeter wave link; a field indicative of modulation and coding scheme (MCS) of each link (such as MCS of each link under the next-generation IEEE 802.11 or UHR standard); a field indicative of equal or unequal modulation (EQM/UNEQM) flag of each link; a field indicative of unequal modulation (UNEQM) pattern of each link; a field indicative of number of spatial streams (NSS) of each link; a field indicative of signal-to-interference-and-noise-ratio (SINR) of each link; a field indicative of received signal strength indicator (RSSI) of each link; a field indicative of target receive power of each link; a field indicative of distributed resource unit (DRU)/regular resource unit (RRU) information of each link, and/or the like. Additionally, some or all subfields of the Short Sector Sweep (SSW) Feedback fields included in IEEE P802.11 REVmf/D1.0 may be added for enhancing beam training feedback and transmission parameter adaptation.

In some implementations, the field indicative of the adaptation parameter of each link includes at least one of: a length field indicative of a length of information related to an identifier of the link; a field indicative of modulation and coding scheme (MCS) of each link (such as MCS of each link under the next-generation IEEE 802.11 or UHR standard); a field indicative of equal or unequal modulation (EQM/UNEQM) flag of each link; a field indicative of unequal modulation (UNEQM) pattern of each link; a field indicative of number of spatial streams (NSS) of each link; a field indicative of signal-to-interference-and-noise-ratio (SINR) of each link; a field indicative of target receive power of each link; a field indicative of received signal strength indicator (RSSI) of each link; a field indicative of distributed resource unit (DRU)/regular resource unit (RRU) information of each link, and/or the like.

In some implementations, the first field includes: a Block ACK Starting Sequence Control field including: a field for indicating that a type of feedback is the adaptation parameters of the one or more links between the AP and the STA; and a sub-type field for indicating that a sub-type of feedback is single-link feedback; and a Block ACK bitmap field including: a field indicative of an identifier of a single link; and a field indicative of an adaptation parameter of the single link.

In some implementations, the field indicative of the adaptation parameter of the single link includes: a field indicative of modulation and coding scheme (MCS) of the single link (such as MCS of the single link under the next-generation IEEE 802.11 or UHR standard); a field indicative of equal or unequal modulation (EQM/UNEQM) flag of the single link; a field indicative of unequal modulation (UNEQM) pattern of the single link, and/or the like.

In some implementations, the field indicative of the adaptation parameter of the single link further includes: a field indicative of number of spatial streams (NSS) of the single link; a field indicative of signal-to-interference-and-noise-ratio (SINR) of the single link; a field indicative of target receive power of each link; a field indicative of received signal strength indicator (RSSI) of each link; a field indicative of distributed resource unit (DRU)/regular resource unit (RRU) information of the single link, and/or the like.

In some implementations, the first field includes: a Block ACK Starting Sequence Control field including: a field for indicating that a type of feedback is the link adaptation parameters; and a Block ACK bitmap field including: a field indicative of a link adaptation parameter.

In some implementations, the field indicative of the link adaptation parameter includes at least one of: a field indicative of modulation and coding scheme (MCS) (such as MCS under the next-generation IEEE 802.11 or UHR standard); a field indicative of equal or unequal modulation (EQM/UNEQM) flag; a field indicative of unequal modulation (UNEQM) pattern; a field indicative of number of spatial streams (NSS); a field indicative of signal-to-interference-and-noise-ratio (SINR); a field indicative of target receive power; a field indicative of received signal strength indicator (RSSI) of each link; a field indicative of distributed resource unit (DRU)/regular resource unit (RRU) information, and/or the like.

According to some implementations, the link adaptation parameters for the single-link STA and Multi-link STA are carried via a Multi-STA Block Acknowledgement (Multi-STA BA) frame.

In some implementations, the request frame is an initial control frame (ICF) (for example, Buffer Status Report Poll (BSRP) or BSRP Non-Trigger Based (NTB) frame), and the response frame is an initial control response (ICR) frame (for example, Multi-STA BA frame).

In some implementations, the request frame can be a link reconfiguration request action frame and the response frame can be a link reconfiguration response or notify action frame.

In some implementations, the response frame includes a second field indicative of support of reporting of the adaptation parameter of the at least one link among the one or more links.

In some implementations, the second field is present in a reconfiguration operation type sub-field of the Reconfiguration Multi-Link Element carried in the link reconfiguration response or notify action frame.

In some implementations, the Multi-STA BA response frame further includes a third field for acknowledge (ACK) of the request frame.

In some implementations, the third field further includes: a Per-AID TID information field including: an AID11 field indicative of an associated identifier of the STA; an ACK type field indicative of a type field for ACK of receiving the request frame; and a TID field indicative of data traffic ID.

According to a second aspect, an AP determines a request frame for obtaining adaptation parameters of one or more links between a station (STA) and the access point (AP); and receives a response frame from the STA, the response frame including a first field indicative of an adaptation parameter of at least one link among the one or more links.

In some implementations, the first field includes an Associated Identifier (AID) Traffic Identifier (TID) information field, and the Per-AID TID information field is used for indicating the first field to indicate the adaptation parameter of the at least one link.

In some implementations, the Per-AID TID information field includes: an AID11 field, an acknowledge (ACK) type field, and a TID field, the AID11 field is indicative of an associated identifier of the STA; the ACK type field and the TID field are used together for indicating the first field to include the adaptation parameter of the at least one link.

In some implementations, the first field includes: a Block ACK Starting Sequence Control field including: a field for indicating that a type of feedback is multi-link feedback; and a field for indicating that a sub-type of feedback is adaptation parameters of a plurality of links between the AP and the STA; and a Block ACK bitmap field including: a field indicative of an identifier of each link of the at least one link; and a field indicative of an adaptation parameter of each link of the at least one link.

In some implementations, the first field includes: a Block ACK Starting Sequence Control field including: a field for indicating that a type of feedback is adaptation parameters of one link or a plurality of links between the AP and the STA; and a Block ACK bitmap field including: a field indicative of an identifier of each link of the at least one link; and a field indicative of an adaptation parameter of each link of the at least one link.

In some implementations, the first field includes: a Block ACK Starting Sequence Control field including: a field for indicating that a type of feedback is the adaptation parameters of the one or more links between the AP and the STA; and a field for indicating that a sub-type of feedback is multi-link feedback; and a Block ACK bitmap field including: a field indicative of an identifier of each link of the at least one link; and a field indicative of an adaptation parameter of each link of the at least one link.

In some implementations, the field indicative of the adaptation parameter of each link includes at least one of: a length field indicative of a length of information related to an identifier of the link; a field indicative of modulation and coding scheme (MCS) of each link (such as MCS of each link under the next-generation IEEE 802.11 or UHR standard); a field indicative of equal or unequal modulation (EQM/UNEQM) flag of each link; a field indicative of unequal modulation (UNEQM) pattern of each link; a field indicative of number of spatial streams (NSS) of each link; a field indicative of signal-to-interference-and-noise-ratio (SINR) of each link; a field indicative of target receive power; a field indicative of received signal strength indicator (RSSI) of each link; a field indicative of distributed resource unit (DRU)/regular resource unit (RRU) information of each link, and/or the like.

In some implementations, wherein the first field includes: a Block ACK Starting Sequence Control field including: a field for indicating that a type of feedback is the adaptation parameters of the one or more links between the AP and the STA; and a sub-type field for indicating that a sub-type of feedback is single-link feedback; and a Block ACK bitmap field including: a field indicative of an identifier of a single link; and a field indicative of an adaptation parameter of the single link.

In some implementations, the field indicative of the adaptation parameter of the single link includes: a field indicative of modulation and coding scheme (MCS) of the single link (such as MCS of the single link under the next-generation IEEE 802.11 or UHR standard); a field indicative of equal or unequal modulation (EQM/UNEQM) flag of the single link; a field indicative of unequal modulation (UNEQM) pattern of the single link, and/or the like.

In some implementations, the field indicative of the adaptation parameter of the single link further includes: a field indicative of number of spatial streams (NSS) of the single link; a field indicative of signal-to-interference-and-noise-ratio (SINR) of the single link; a field indicative of target receive power; a field indicative of received signal strength indicator (RSSI) of each link; a field indicative of distributed resource unit (DRU)/regular resource unit (RRU) information of the single link, and/or the like.

In some implementations, the request frame is an initial control frame (ICF) (for example, BSRP or BSRP NTB frame), and the response frame is an initial control response (ICR) frame (for example, Multi-STA BA frame).

In some implementations, the response frame includes a second field indicative of support of reporting of the adaptation parameter of the at least one link among the one or more links.

In some implementations, the second field is present in a reconfiguration operation type sub-field of the Reconfiguration Multi-Link Element carried in the link reconfiguration response or notify action frame.

In some implementations, the response frame further includes a third field for acknowledge (ACK) of the request frame.

In some implementations, the third field further includes: a Per-AID TID information field including: an AID11 field indicative of an associated identifier of the STA; an ACK type field indicative of a type field for ACK of receiving the request frame; and a TID field indicative of data traffic ID.

According to third aspect, a communication apparatus is provided. The communication apparatus has a function of implementing any one of the first or second aspects or possible implementations thereof. For example, the communication apparatus includes a corresponding module, unit, or means (means) for performing operations in the first aspect. The module, unit, or means may be specifically implemented by using software, may be implemented by using hardware, or may be implemented by using software in combination with hardware.

According to fourth aspect, a communication apparatus is provided. The communication apparatus includes one or more processors coupled with a memory. The memory is configured to store a part or all of a necessary computer program or instructions for implementing a function in any one of the first or second aspects. The one or more processors may execute the computer program or the instructions, and when the computer program or the instructions is/are executed, the communication apparatus is enabled to implement the method in any suitable design or implementation of any one of the first or second aspects.

In some implementations, the communication apparatus may further include an interface circuit, and the processor is configured to communicate with another apparatus or component through the interface circuit.

In some implementations, the communication apparatus may further include the memory.

The communication apparatus may be an AP or a STA, a module in an AP or a STA, or a chip responsible for a communication function in an AP or a STA, for example, a modem chip (also referred to as a baseband chip) or an SoC chip or an SIP chip that includes a modem module.

According to a fifth aspect, a communication system is described, which includes the STA as described in the first aspect and the AP as described in the second aspect.

According to a sixth aspect, a computer-readable storage medium is provided. The computer-readable storage medium stores computer-readable instructions, and when a computer reads and executes the computer-readable instructions, the computer is enabled to perform the method in any one of the implementations of the first aspect or the second aspect.

According to a seventh aspect, a computer program product is provided. When a computer reads and executes the computer program product, the computer is enabled to perform the method in any one of the suitable designs of the first aspect or the second aspect.

According to one aspect of this disclosure, there is provided a communication method comprising: transmitting or receiving a first frame indicating a plurality of communication parameters of a plurality of links; and receiving or transmitting a plurality of data frames via the plurality of links using the plurality of communication parameters.

In some implementations, the method is performed by a first multi-link device (MLD); the plurality of links are between the first MLD and a second MLD; and one of the first and second MLDs is an access point (AP) MLD comprising a plurality of APs, and the other one of the first and second MLDs is a station (STA) MLD comprising a plurality of STAs, and the plurality of links being formed between the plurality of APs and the plurality of STAs.

In some implementations, the method further comprises: transmitting or receiving a second frame for requesting the plurality of communication parameters.

In some implementations, the first frame is transmitted via one of the plurality of links.

In some implementations, the first frame is transmitted through a sub-7.25 gigahertz (GHz) frequency band.

In some implementations, at least one of the plurality of links is in a millimeter-wave (MMW) frequency band.

In some implementations, the first frame is a multi-STA block acknowledgement (multi-STA Block ACK) frame conveying control or feedback information including the plurality of communication parameters.

In some implementations, the first frame comprises a Per Associated Identifier (AID) Traffic Identifier (TID) Info field indicating the plurality of communication parameters.

In some implementations, the Per AID TID info field comprises an acknowledge (ACK) Type field and a TID field; and values of the ACK Type field and the TID field indicate that the Per AID TID Info field is for conveying the control or feedback information.

In some implementations, the ACK Type field has a value of zero and the TID field has a value of 13 for indicating that the Per AID TID Info field is for conveying the control information or feedback.

In some implementations, the Per AID TID info field comprises an AID TID Info field; and the AID TID Info field comprises an AID11 field, the ACK Type field, and the TID field.

In some implementations, the AID11 field has a value greater than 2007.

In some implementations, the AID TID Info field has a length of two bytes, the AID11 field includes first 11 bits of the AID TID Info field, followed by the ACK Type field of one bit and subsequently the TID field of four bits.

In some implementations, the AID TID Info field has a length of two bytes, the AID11 field has a length of 11 bits, the ACK Type field has a length of one bit, and the TID field has a length of four bits.

In some implementations, wherein the Per AID TID info field comprises a Type field indicating that the type of the control or feedback information is multi-link feedback, or indicating that the type of the control or feedback information is multi-link adaptation, or indicating that the type of the control or feedback information is link adaptation.

In some implementations, the Type field has a value of two or three for indicating that the type of the control or feedback information is the multi-link feedback, or has a value of four or five for indicating that the type of the control or feedback information is the multi-link adaptation, or has a value of four for indicating that the type of the control or feedback information is the link adaptation.

In some implementations, the Per AID TID info field comprises a Sub-Type field; and the Type field indicates that the type of the control or feedback information is the multi-link feedback and the Sub-Type field indicates that the type of multi-link feedback is multi-link adaptation, or the Type field indicates that the type of the control or feedback information is the link adaptation and the Sub-Type field indicates that the link adaptation is single-link adaptation or multi-link adaptation.

In some implementations, the Sub-Type field has a value of two to indicate that the type of multi-link feedback is the multi-link adaptation; or the Sub-Type field has a value of zero to indicate that the type of link feedback is single-link adaptation, or a value of one to indicate that the type of link feedback is the multi-link adaptation.

In some implementations, the Per AID TID info field comprises a Number of Links field indicating a number of the plurality of links.

In some implementations, the Per AID TID info field comprises a Block Ack Starting Sequence Control field; the Block Ack Starting Sequence Control field comprises a Starting Sequence Number Control field; the Starting Sequence Number Control field comprises the Type field and a Type-Specific Control Info field; and the Type-Specific Control Info field comprises the Number of Links field.

In some implementations, the Type-Specific Control Info field comprises the Sub-Type field.

In some implementations, the Block Ack Starting Sequence Control field has a length of two bytes, the Starting Sequence Number Control field has a length of 12 bits, the Type field has a length of four bits; the Type-Specific Control Info field has a length of eight bits, and the Number of Links field has a length of four bits.

In some implementations, the Sub-Type field indicates that the type of multi-link feedback is multi-link adaptation and has a length of three bits, or the Sub-Type field indicates that the link adaptation is single-link adaptation or multi-link adaptation, and has a length of one bit.

In some implementations, the Per AID TID info field comprises a Block Ack Bitmap field conveying the control or feedback information including the plurality of communication parameters.

In some implementations, the Block Ack Starting Sequence Control field comprises a Fragment Number field for indicating a length of the control or feedback information included in the Block Ack Bitmap field.

In some implementations, the Block Ack Bitmap field has a length of four, eight, 16, 32, 64, or 128 bytes, and the Fragment Number field has a length of four bits.

In some implementations, the first frame comprises a Multi-Link Reconfiguration Element conveying the plurality of communication parameters.

In some implementations, the first frame is an initial control response (ICR) frame in response to an initial control frame (ICF).

In some implementations, a STA Control field of the Multi-Link Reconfiguration Element comprises a Reconfiguration Operation Type field for indicating that the first frame is a link adaptation feedback for conveying control or feedback information.

In some implementations, the Reconfiguration Operation Type field has a value of five for indicating that the first frame is the link adaptation feedback.

In some implementations, the STA Control field of the Multi-Link Reconfiguration Element comprises a Link Adaptation Parameters Present field for indicating a presence of the plurality of communication parameters.

In some implementations, the Multi-Link Reconfiguration Element has a length of two bytes, the Reconfiguration Operation Type field has a length of four bits, and the Link Adaptation Parameters Present field comprises one of the last two bits of the Multi-Link Reconfiguration Element.

In some implementations, a STA Info field of the Multi-Link Reconfiguration Element comprises the plurality of communication parameters.

In some implementations, the plurality of communication parameters comprise: a modulation and coding scheme (MCS) of each of the plurality of links; an indication of equal modulation (EQM) or unequal modulation (UNEQM) of each of the plurality of links; an UNEQM pattern of each of the plurality of links; a number of spatial streams (NSS) of each of the plurality of links; a signal-to-interference-and-noise-ratio (SINR) of each of the plurality of links; a received signal strength indicator (RSSI) of each of the plurality of links; a target receive power of each of the plurality of links; a resource unit (RU) information of each of the plurality of links; or a combination thereof.

According to one aspect of this disclosure, there is provided a communication apparatus configured to perform any of the above-described methods.

According to one aspect of this disclosure, there is provided a communication apparatus comprising: one or more processors functionally coupled to one or more non-transitory computer-readable storage media storing computer-executable instructions; wherein the instructions, when executed, cause the one or more processors to perform any of the above-described methods via a wireless communication interface.

According to one aspect of this disclosure, there is provided one or more non-transitory computer-readable storage media comprising computer-executable instructions, wherein the instructions, when executed, cause one or more processors to perform any of the above-described methods via a wireless communication interface.

According to one aspect of this disclosure, there is provided a computer program product for storing instructions which, when executed, cause an apparatus to perform any of the above-described methods.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform any of the above-described methods.

According to one aspect of this disclosure, there is provided an apparatus comprising: one or more processors functionally connected to one or more memories for performing any of the above-described methods.

According to one aspect of this disclosure, there is provided an apparatus for performing any of above-described methods and their embodiments. Specifically, the apparatus includes one or more units for performing any of above-described methods and their embodiments.

According to one aspect of this disclosure, there is provided a communication system. The communication system includes a first communication-node and/or a second communication-node, the first communication-node is configured to perform any of the above-described methods regarding with the first communication-node as stated above, and the second communication-node is configured to perform any of the above-described methods regarding with the second communication-node as stated above.

The methods (and related processors, apparatuses, systems, computer-readable storage media, and/or the like) disclosed herein have various advantages and technical benefits.

For example, the methods disclosed herein provide multi-link adaptation for transmission optimization, which enables MLDs to dynamically adjust transmission parameters (such as modulation, data rates, power levels, and/or the like) across multiple frequency bands, thereby increasing or even optimizing throughput, and reducing or even minimizing latency. The methods disclosed herein provide enhanced transmission scheduling and conflict resolution, which improves transmission efficiency by managing transmission opportunities (TXOP) across multiple links, reducing conflicts and retransmissions, thus enhancing overall network performance. Moreover, the methods disclosed herein provide scalability and flexibility across frequency bands, which ensures mechanisms are scalable across both sub-7.25 GHz and higher-frequency bands (42 GHz to 71 GHz), supporting future WI-FI® developments and improving performance across diverse environments.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing a three-link Multi-Link Operation (MLO) connection between an AP Multi-link Device (MLD) and an STA MLD; according to some embodiments of this disclosure;

FIG. 5 is a schematic diagram showing the structure of a multi-STA Block Ack frame for multi-link feedback, according to some embodiments of this disclosure, wherein the multi-Link feedback may be conveyed within one of the Per AID TID Info fields of the multi-STA BA frame;

FIG. 6 is a schematic diagram showing the format of the AID TID info subfield of the Per AID TID Info field shown in FIG. 5, according to some embodiments of this disclosure;

FIG. 7 is a schematic diagram showing the format of the Block Ack Starting Sequence Control subfield of the Per AID TID Info field shown in FIG. 5, according to some embodiments of this disclosure;

FIG. 8 is a schematic diagram showing the format of the Block Ack Starting Sequence Control subfield shown in FIG. 7, according to some embodiments of this disclosure;

FIG. 9 a schematic diagram showing the format of the Block ACK Bitmap subfield of the Per AID TID Info field shown in FIG. 5, according to some embodiments of this disclosure;

FIG. 10 is a schematic diagram summarizing the details of the structure of the Per AID TID Info field shown in FIG. 5 adapted to carry multilink feedback, according to some embodiments of this disclosure;

FIG. 11 is a schematic diagram showing the structure of the Per AID TID Info field shown in FIG. 5 adapted to carry multilink feedback, according to some other embodiments of this disclosure;

FIG. 12 is a schematic diagram showing the structure of the Per AID TID Info field shown in FIG. 5 adapted to carry multilink feedback, according to yet some other embodiments of this disclosure;

FIG. 13 is a schematic diagram showing a three-link Multi-Link Operation (MLO) connection between an AP Multi-link Device (MLD) and an STA MLD; according to some other embodiments of this disclosure;

FIG. 14 is a schematic diagram showing the structure of the conventional STA Control field of a Multi-Link Reconfiguration Element;

FIG. 15 is a schematic diagram showing the structure of the STA Control field of a Multi-Link Reconfiguration Element, according to some embodiments of this disclosure; and

FIG. 16 is a schematic diagram showing the structure of the STA Info field of a Multi-Link Reconfiguration Element, according to some embodiments of this disclosure.

### DETAILED DESCRIPTION

Numerous details are described herein to provide a thorough understanding of the example implementations illustrated in the accompanying drawings. However, some implementations may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the implementations described herein.

### A. System Structure

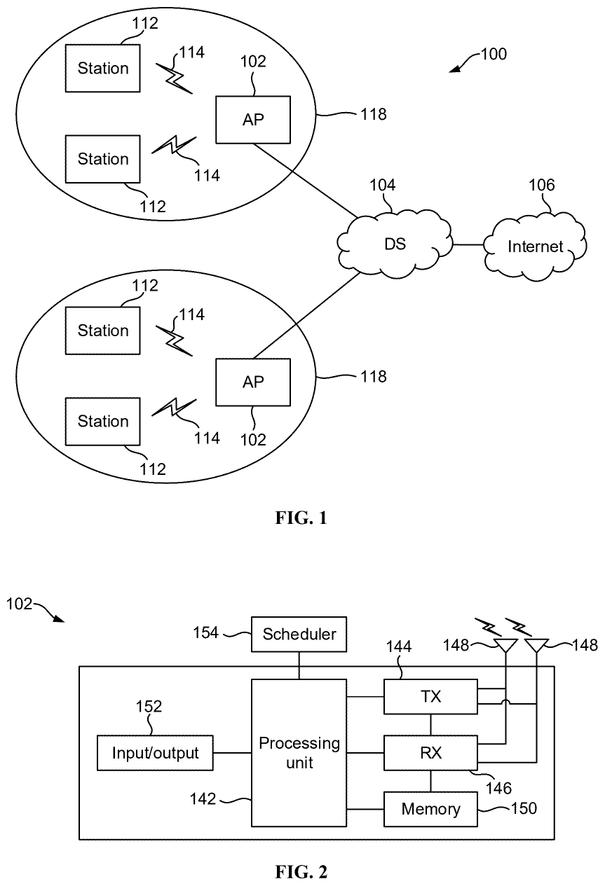

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (denoted non-AP STAs or simply STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises a processing structure 142, a wireless communication interface, at least one memory 150, and one or more input/output components or interfaces 152, wherein the wireless communication interface may comprise necessary components, such as at least one transmitter (TX) 144, at least one receiver (RX) 146, one or more antennas 148, and/or the like, for wireless communication with one or more other wireless communication devices. Sometimes, a TX 144 and a RX 146 may be collectively referred to as a transceiver, and may be integrated into a single component in some embodiments.

A scheduler 154 may be coupled to the processing structure 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing structure 142 is configured for performing various processing operations such as signal coding, data processing, power control, input/output processing, or any other suitable functionalities. The processing structure 142 may comprise one or more processors such as one or more microprocessors, one or more microcontrollers, one or more digital signal processors, one or more Field Programmable Gate Arrays (FPGAs), one or more Application-Specific Integrated Circuits (ASICs), and/or the like. In some embodiments, the processing structure 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing structure 142 and data used, generated, or collected by the processing structure 142. For example, the memory 150 may store instructions of software, software systems, or software modules that are executable by the processing structure 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

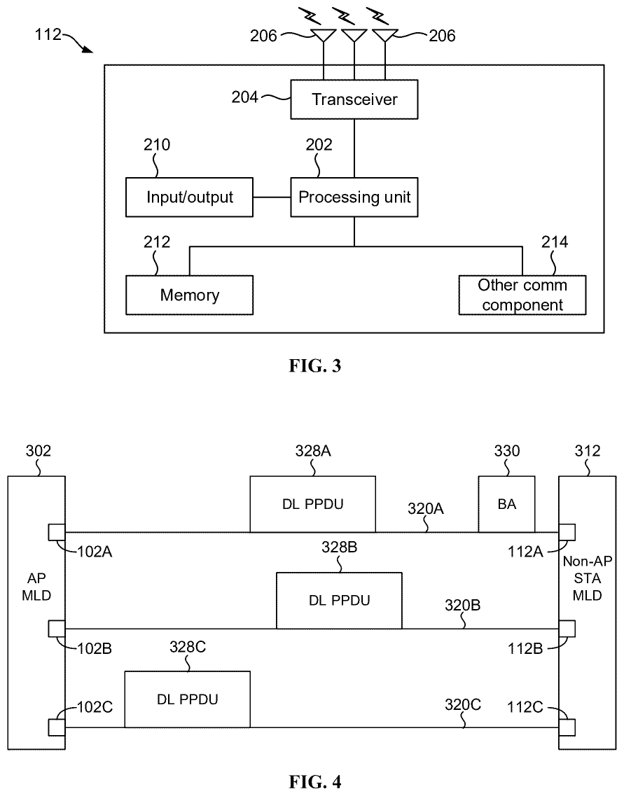

FIG. 3 is a simplified schematic diagram of a STA 112. As shown, the STA 112 comprises a processing structure 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing structure 202 is configured for performing various processing operations such as signal coding, data processing, power control, input/output processing, or any other functionalities to enable the STA 112 to access and join the communication system 100 and operate therein. The processing structure 202 may also be configured to implement some or all of the functionalities of the STA 112 described in this disclosure. The processing structure 202 may comprise one or more processors such as one or more central processing units (CPUs), one or more microprocessors, one or more microcontrollers, one or more digital signal processors, one or more accelerators, one or more graphic processing units (GPUs), one or more tensor processing units (TPU), one or more FPGAs, one or more ASICs, and/or the like. Examples of the processing structure 202 may be one or more ARM® microprocessors (ARM is a registered trademark of Arm Ltd., Cambridge, UK) manufactured by a variety of manufactures such as Qualcomm of San Diego, California, USA, under the ARM® architecture, one or more INTEL® microprocessors (INTEL is a registered trademark of Intel Corp., Santa Clara, CA, USA), one or more AMD® microprocessors (AMD is a registered trademark of Advanced Micro Devices Inc., Sunnyvale, CA, USA), and/or the like. In some embodiments, the processing structure 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing structure 202 and data used, generated, or collected by the processing structure 202. For example, the memory 212 may store instructions of software, software systems, or software modules that are executable by the processing structure 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### Wireless Communication Employing Multi-Link Adaptation

One of the most transformative features introduced in IEEE 802.11be (WI-FI® 7) is Multi-Link Operation (MLO), which allows devices to operate on multiple frequency bands and/or channels simultaneously. This capability promises to improve network performance by increasing throughput, reducing latency, enhancing reliability, and/or the like, particularly in challenging environments with high interference or congestion. A device with MLO capability is generally denoted a Multi-link Device (MLD), which comprises a plurality of link components such as a plurality of transmitters (Tx), a plurality of receivers (Rx), or a plurality of transceivers (wherein a transceiver is a combination of a Tx and an Rx), such that the MLD may simultaneously communicate with one or more other devices (such as one or more other MLDs, a plurality of single-link devices, and/or the like) via a plurality links in a plurality of frequency bands and/or channels. For example, an AP MLD may comprise a plurality of link components, each of which may be considered an affiliated AP 102. Similarly, a non-AP STA MLD may comprise a plurality of link components, each of which may be considered an affiliated non-AP STA 112.

Herein, the term “link adaptation” refers to the capability of the communication system 100 to adapt communication parameters to the quality of the wireless link. In MLO, the communication system 100 generally requires multi-link adaptation, that is, the capability to adapt communication parameters to the quality of each of a plurality of wireless links. In multi-link adaptation, various communication parameters may be adapted to the quality of the corresponding wireless link. Examples of such communication parameters may include modulation and coding scheme (MCS) (such as ultra-high reliability (UHR) MCS and/or the like), signal to interference and noise ratio (SINR), equal modulation (EQM) or unequal modulation (UNEQM) pattern, data rates, power levels, number of spatial streams (NSS), resource unit (RU) information (such as distributed resource unit (DRU) and/or regular resource unit (RRU) information), received signal strength indicator (RSSI), and/or the like, of each of the plurality of wireless links.

In tandem with these advancements, the IEEE 802.11bn standard (WI-FI® 8) has been evolving to address the growing demand for more efficient and adaptive network management, especially in scenarios where WI-FI® devices may need to update their transmission parameters to enhance their reliability, to balance performance with power consumption, or when becoming temporarily unavailable due to participation in other non-WI-FI activities, such as those related to Bluetooth or Global Positioning System (GPS). One such area of focus is the enhancement of link adaptation, power-saving mechanisms, and the management of dynamic unavailability in devices, which are important for optimizing both power consumption and transmission reliability in real-world applications.

In prior art, several contributions have explored various single-link adaptation mechanisms to enhance transmission reliability and reduce unnecessary retransmissions, for example, IEEE 802.11-20/1005r1, “Yet Another Fast Link Adaptation Attempt,” by Jinjing Jiang, published on Mar. 15, 2020, accessible at https://mentor.ieee.org/802.11/dcn/20/11-20-1005-01-00be-yet-another-fast-link-adaptation-attempt.pptx, and IEEE 802.11-24/0209r8, “IEEE P802.11 Wireless LANs, specification Framework for TGbn,” by Ross Jian Yu, published on Jan. 17, 2025.

While these motions and contributions are a significant step forward for single-link operation, the rapid adoption of MLO in WI-FI® 7 necessitates a solution for applying these mechanisms to MLDs in, for example, WI-FI® 8, and/or similar standards and technologies. MLO enables devices to simultaneously utilize multiple frequency bands, ranging from traditional sub-7.25 gigahertz (GHz) unlicensed bands (such as the 2.4 GHz to 7.25 GHz range) to higher-frequency bands, for example, from 42 GHz to 71 GHz. This wide range of frequencies opens up new opportunities for improving transmission efficiency, especially in environments with high interference or congestion.

Herein, various embodiments of systems, apparatuses, methods, and non-transitory computer-readable storage devices for wireless communication employing multi-link operation with multi-link adaptation are disclosed. The introduction of multi-link adaptation mechanisms enables MLDs to dynamically adjust their capabilities and transmission parameters based on network conditions, optimizing transmission scheduling, achievable throughput and latency across the different frequency bands in use. This is especially important as MLDs may operate across a wide range of unlicensed bands, including emerging higher-frequency bands, where environmental factors and network conditions can vary significantly. The ability to seamlessly adapt across these links provides MLDs with the flexibility required to maintain high levels of performance in diverse environments.

Thus, implementing the capabilities and features introduced in 11bn to MLDs is important for WI-FI® 8's MLO. Such implementation not only enhances the performance and energy efficiency of MLO but also ensures that the technology can scale effectively across both existing and emerging WI-FI® bands. As MLDs become more prevalent, the integration of robust unavailability reporting, power-saving, and link adaptation mechanisms may be important for optimizing their performance and ensuring reliable connectivity across a wide range of use cases.

The rapid evolution of WI-FI® technologies, particularly with the introduction of MLO in WI-FI® 7 and the upcoming enhancements in WI-FI® 8, presents several technical challenges that need to be addressed to fully realize the potential of these advancements. These challenges include:

### Link Adaptation in Multi-Link Scenarios

One of the main advantages of MLO is its ability to dynamically utilize multiple frequency bands, from lower-frequency bands (such as sub-7.25 GHz bands) to higher-frequency bands (such as 42 GHz to 71 GHz bands). However, this dynamic adaptation across multiple links requires conventional technologies to use sophisticated link adaptation mechanisms that are capable of adjusting transmission parameters, including data rates, modulation and coding schemes, power levels, beamforming training feedback, and/or the like, based on the network's changing conditions. Conventional mechanisms are typically designed for single-link operation and do not provide the flexibility required to adapt across multiple links with varying interference, congestion, and environmental factors.

### Scalability of Features Across Emerging Frequency Bands

With the expansion of WI-FI® operation into higher-frequency bands (such as 42 GHz to 71 GHz), new challenges arise in managing MLO efficiently. These higher-frequency bands can be more susceptible to environmental factors such as increased attenuation and interference. To fully leverage these emerging bands, WI-FI® devices need to incorporate robust mechanisms for multi-link adaptation, unavailability reporting, power saving, and/or the like that can scale across both existing and future WI-FI® bands, and/or the like.

The methods disclosed herein address these challenges by extending the link adaptation features introduced in IEEE 802.11bn to MLDs (such as MLDs used in WI-FI® 8). By using the methods disclosed herein for dynamic adaptation, efficient power management, enhanced transmission scheduling across multiple links, and/or the like, the methods disclosed herein may significantly improve the reliability, energy efficiency, performance, and/or the like for WI-FI® networks in MLO scenarios, especially as they transition to operating across diverse frequency bands, including higher-frequency unlicensed bands.

The methods disclosed herein provide a comprehensive solution to the technical challenges posed by MLO in, for example, WI-FI® 7 and WI-FI® 8. The methods disclosed herein extend the existing power-saving, unavailability reporting, link adaptation mechanisms, and/or the like to MLDs, thereby ensuring that these devices can efficiently operate across multiple frequency bands and achieve improved or even optimized performance in diverse environments. As will be described in more details below, the methods disclosed herein comprise various features in various embodiments, such as:

### Multi-Link Adaptation for Transmission Optimization

The methods disclosed herein introduce a multi-link adaptation signaling mechanism that allows MLDs to dynamically feedback their desired transmission parameters, such as MCS, SINR, RSSI, EQM or UNEQM pattern, data rates, power levels, beamforming training feedback, and/or the like, based on real-time network conditions. This adaptation mechanism operates across multiple frequency bands, including, for example, both sub-7.25 GHz and higher-frequency bands (42 GHz to 71 GHz), enabling MLDs to maintain improved or even optimal throughput, and reduce or even minimize latency in environments with varying interference and congestion. The ability to adapt across multiple links enhances overall transmission reliability and efficiency, ensuring high-quality connectivity even in challenging network conditions.

### Scalability and Flexibility Across Frequency Bands

With the expanding WI-FI® ecosystem, including the use of higher-frequency unlicensed bands, the methods disclosed herein provide sufficient scalability and flexibility to operate across both existing and emerging WI-FI® bands. In some embodiments, the herein-disclosed multi-link adaptation, unavailability reporting, power-saving mechanisms, and/or the like are designed to support MLDs in all suitable frequency ranges, such as the sub-7.25 GHz bands and the higher-frequency 42 GHz to 71 GHz bands, thus ensuring that the WI-FI® network can scale efficiently as new spectrum becomes available.

Therefore, the methods disclosed herein enhance the performance, reliability, energy efficiency, and/or the like for WI-FI® networks such as WI-FI® 7 and WI-FI® 8 networks by addressing the unique challenges posed by MLO. Through advanced adaptive link adaptation as well as advanced or even optimized transmission scheduling, the methods disclosed herein enable MLDs to operate more efficiently across multiple frequency bands, thereby ensuring reliable and high-performance connectivity in diverse environments.

In various embodiments, the methods disclosed herein may be suitable for the standardization of next generation of IEEE 802.11 for MLOs.

In various embodiments, the methods disclosed herein may be suitable for use by various devices such as WI-FI® APs 102 and STAs 112 with MLOs, such as WI-FI® 8 Multi-Link APs, future MLDs, and/or the like.

It is important to extend this link adaptation approach to the MLO scenario to enhance transmission reliability and reduce unnecessary retransmissions across multiple links.

For example, for IEEE 802.11bq MLDs, links operating on higher-frequency unlicensed bands (ranging, for example, from 42 GHz to 71 GHz) are significantly impacted by path loss. As a result, the transmission parameters and beamforming training feedback for these links need to be updated more frequently to maintain and improve their reliability.

In some embodiments, such as in systems following IEEE 802.11bq standard, it may be preferable to transmit the Multi-Link Adaptation feedback over one of the active links operating in the sub-7.25 GHz unlicensed band (ranging from 2.4 GHz to 7.25 GHz). This can help minimize signaling overhead and increase the likelihood of successful reception, compared to transmitting it over the millimeter-wave (MMW, also denoted “mmWave”) link.

In some embodiments, the desired link adaptation parameters of the MMW link may be transmitted over one of the active links operating in the sub-7.25 GHz unlicensed band (ranging from 2.4 GHz to 7.25 GHz). This increases the likelihood of successful reception, compared to transmitting it over the MMW link.

FIG. 4 is a schematic diagram showing a three-link Multi-Link Operation (MLO) connection with certain links having unavailable periods; according to some embodiments of this disclosure. In this example, the AP MLD 302 comprises three link components 102A, 102B, and 102C (for ease of description, each may be considered an AP 102), and the STA MLD 312 comprises three link components 112A, 112B, and 112C (for ease of description, each may be considered a non-AP STA 112). The AP MLD 102 is in communication with the STA MLD 112 simultaneously via three links 320A (between AP 102A and STA 112A), 320B (between AP 102B and STA 112B), and 320C (between AP 102C and STA 112C).

The AP MLD 302 may transmit a plurality of DL PPDUs via the multiple links 320A to 320C simultaneously or at different time instants as needed. For example, as shown in FIG. 4, the AP MLD 302 may transmit a DL PPDU 328A via the link 320A, a DL PPDU 328B via the link 320B, and a DL PPDU 328C via the link 320C at different time instants. After receiving the DL PPDUs 328A to 328C, the STA MLD 312 may send a multi-STA block acknowledgement (“BA”, “Block ACK”, or “multi-STA Block ACK”) frame 330 via, for example, link 320A.

As those skilled in the art will appreciate, when transmitting the DL PPDUs 328A to 328C, the AP MLD 302 may adapt one or more communication parameters for transmitting each of the DL PPDUs 328A to 328C to the quality of the corresponding link 320A, 320B, or 320C. In some embodiments, multi-link adaptation may be achieved by using the multi-STA Block Ack frame 330 for conveying multi-link adaptation information. For example, both AP MLD 302 and non-AP STA MLD 312 can send adaptation parameters based on the received UL and DL PPDU, respectively. An STA MLD 312 may send adaptation parameters to an AP MLD 302 based on the recently received PPDU from the AP MLD 302 or from the non-AP STA, such that the link adaptation parameters may be aggregated from the Block Ack in the same frame.

In some embodiments, the multi-STA BA frame 330 may include a Block Ack bitmap if the preceding PPDU 328A, 328B, and/or 328C includes quality of Service (QoS) data frame(s) that solicit an immediate response (e.g., Ack or Block Ack context). The multi-STA BA frame 330 may also or alternatively include feedback information when the non-AP STA MLD 312 is operating in a mode that allows inclusion of feedback information (for example, Multi-Link Coexistence unavailability reports).

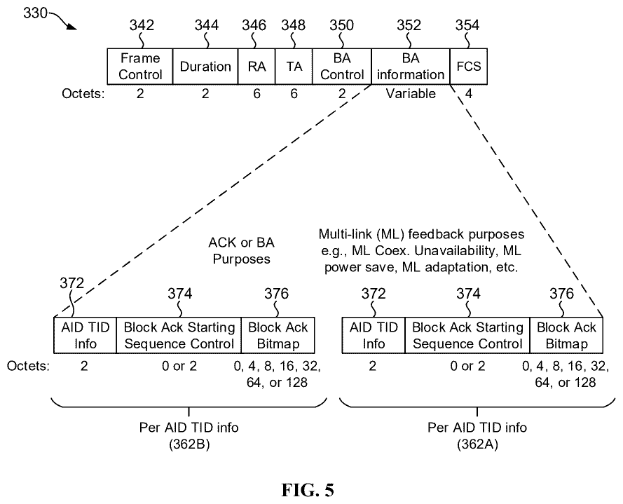

FIG. 5 is a schematic diagram showing the structure of the multi-STA BA frame 330 for conveying, multi-link adaptation information, according to some embodiments of this disclosure, wherein the multi-link adaptation information may be conveyed within one of the Per AID TID Info fields of the multi-STA BA frame 330 (wherein “AID” refers to “Associated Identifier” and “TID” refers to “Traffic Identifier”).

As shown, the Multi-STA BA frame 330 in this example comprises a two-byte Frame Control field 342, a two-byte Duration field 344, a six-byte Receiver Address (RA) field 346, a six-byte Transmitter Address (TA) field 348, a BA Control field 350, a BA Information field 352 of a variable size, and a four-byte Frame Check Sequence (FCS) field 354.

The multi-STA BA frame 330 allows for a plurality of Per AID TID Info subfields 362 (each comprising the information of all links) to be included in the BA Information field 352. By using the Per AID TID Info subfields 362, the multi-STA BA frame 330 may carry various multi-link feedback such as multi-link Coexistence Unavailability report, multi-link adaptation, multi-link power saving feedback information, and/or the like.

In the example shown in FIG. 5, the BA Information field 352 comprises two Per AID TID Info subfields 362A and 362B, with one Per AID TID Info subfield 362A conveying the multi-link solicited or unsolicited feedback, such as the multi-link Coexistence Unavailability report, multi-link adaptation, multi-link power saving feedback information, and/or the like, and the other Per AID TID Info subfield 362B designated for acknowledging the multi-link feedback request or initial control frame sent by the AP MLD 302.

As those skilled in the art will appreciate, traffic associated with a specific TID may be mapped to multiple links while one Block Ack (per a <AID, TID> pair) is transmitted over a single link. More specifically, the IEEE 802.11be draft states: “For each TID, there shall not be more than one block ack agreement established between two MLDs and the agreement shall apply to all the links that the TID is mapped to (i.e., there are no independent block ack agreements for each TID on a per-link basis)”, and “When a TID is mapped to more than one link, a STA affiliated with a recipient MLD may provide reception status (if available) to the STA affiliated with the originator MLD that is operating on the same link, indicating successful reception of any MPDU that belongs to that TID and has an ack policy other than No Ack and that is received by a STA affiliated with the recipient MLD that is operating on a different link”.

Therefore, in some embodiments, one of the Per AID TID Info subfields 362 in the Multi-STA BA frame 330 may be used to carry the multi-link adaptation feedback information for each affiliated STA 112, ensuring alignment with the TID QoS constraints.

The details of the Per AID TID Info subfields 362 are now described.

As shown in FIG. 5, each Per AID TID Info subfield 362 comprises a two-byte AID TID Info subfield 372, and may optionally further comprise a two-byte Block Ack Starting Sequence Control subfield 374, and a Block Ack Bitmap subfield 376 having a length of four, eight, 16, 32, 64, or 128 bytes.

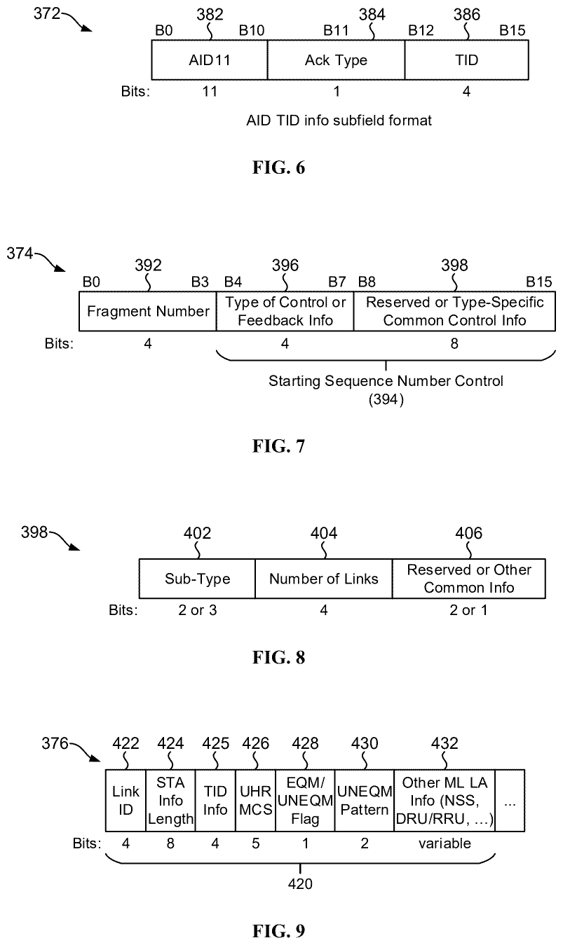

FIG. 6 is a schematic diagram showing the format of the AID TID Info subfield 372, according to some embodiments of this disclosure. As shown, in these embodiments, 11 bits of the AID TID Info subfield 372 (for example, bits B0, B1, . . . , B10; denoted the AID11 subfield 382) are used for indicating the AID, one (1) bit of the AID TID Info subfield 372 (for example, bit B11; denoted the ACK Type subfield 384) is used for indicating Ack Type, and four (4) bits (for example, bits B12, B13, . . . , B15; denoted the TID subfield 386) are used for indicating the TID.

The non-AP STA MLD 312 may set the value of the AID11 subfield 382 to the value of the AID of the AP MLD 302. In some embodiments, any special AID greater than 2007 may also be used as an identification for this special Per AID TID Info field 362.

The one-bit ACK Type subfield 384 and the four-bit TID subfield 386 may be combined for indicating if this Per AID TID Info subfield 362 is sent for Ack or BA (that is, being the Per AID TID Info subfield 362B), or other feedback/control information (that is, being the Per AID TID Info subfield 362A).

According to the Draft P802.11bn/D0.1, the combination of the Ack Type subfield 384 having a value of zero (0) and the TID subfield 386 having a value of 13 is used to indicate the intended use of the Per AID TID Info subfield 362 for conveying feedback.

In some embodiments, the combination of the Ack Type subfield 384 having a value of zero (0) and the TID subfield 386 having a value of 13 is used to indicate the intended use of the Per AID TID Info subfield 362 for conveying control information or feedback as shown in TABLE 1. In other words, TABLE 1 below revised the corresponding table in Draft P802.11bn/D0.1 by defining Ack Type subfield value of zero (0) and the TID subfield value of 13 (which is a reserved combination in Draft P802.11bn/D0.1) as the indication of the presence of Block Ack Starting Sequence Control subfield 374 and Block Ack Bitmap subfield 376 in the corresponding Per AID TID info subfield 362, and the context of the corresponding Per AID TID Info subfield 362 is Feedback and/or Control information.

TABLE 1

| | | Presence of | |
|---|---|---|---|
| | | Block Ack | |
| Ack | | Starting Sequence | |
| Type | TID | Control subfield | Context of a Per AID TID Info |
| subfield | subfield | and Block Ack | subfield in a Multi-STA Block Ack |
| values | values | Bitmap subfields | frame |
| 0 | 0-7 | Present | Block acknowledge context: |
| | | | Sent as an acknowledgement to |
| | | | QoS Data frames that solicit a |
| | | | Block Ack frame response or |
| | | | to a BlockAckReq frame. |
| 1 | 0-7 | Not present | Acknowledgement context: |
| | | | Sent as an acknowledgement to |
| | | | a QoS Data or QoS Null frame |
| | | | that solicits an Ack frame |
| | | | response. |
| 0 or 1 | 8-12 | N/A | Reserved |
| 0 | 13 | Present | Feedback/Control info |
| 1 | 13 | N/A | Reserved |
| 0 | 14 | N/A | Reserved |
| 1 | 14 | Not present | All ack context: |
| | | | Sent as an acknowledgement to an |
| | | | A-MPDU that contains an MPDU |
| | | | that solicits an immediate |
| | | | response and all MPDUs contained |
| | | | in the A-MPDU are received |
| | | | successfully. |
| 0 | 15 | N/A | Reserved |
| 1 | 15 | Not present | Management/PS-Poll frame |
| | | | acknowledgement context: |
| | | | Sent as an acknowledgement to a |
| | | | Management or PS-Poll frame. |

In some embodiments, other reserved values of the Ack type and TID subfields may also be repurposed for carrying the Multi-Link solicited or unsolicited feedback, such as multi-link Coexistence Unavailability report, multi-link adaptation, multi-link power saving feedback information, and/or the like.

While in some embodiments the AID11 subfield 382 may store the AID of the STA MLD 312, in some other embodiments where one of the Per AID TID Info subfields 362 in the Multi-STA BA 330 is used to carry the multi-link adaptation feedback information for each affiliated STA 112, the value of the AID11 subfield 382 of the Per AID TID Info subfield 362 in the Multi-STA BA 330 may be set to a special AID that is greater than 2007, with the TID subfield 386 being set to a value corresponding to the TID mapped to the respective link. As those skilled in the art will appreciate, each Per AID TID Info subfield 362 comprises the information of all or some links. The TID and ACK Type both indicate that this Per AID TID Info subfield 362 comprises feedback or control information.

Conventionally, the 16-bit Block ACK Starting Sequence Control subfield 374 comprises a four-bit Fragment Number for indicating the length of the Block Ack Bitmap subfield 376 in case of BA/ACK purposes, and a 12-bit Starting Sequence Number Control field for indicating the starting sequence number in case of BA/ACK purposes.

In some embodiments as shown in FIG. 7, the 16-bit Block ACK Starting Sequence Control subfield 374 may be used for indicating the information control. More specifically, the four-bit Fragment Number 392 may be reused to indicate the length of the feedback or control information included in the Block Ack Bitmap subfield 376; four (4) bits of the 12-bit Starting Sequence Number Control subfield 394 (denoted the Type subfield 396) may be reused to indicate the type of control or feedback information, and the remaining eight (8) bits of the 12-bit Starting Sequence Number Control subfield 394 (denoted the Type-Specific Common Control Info subfield 398) may be reserved or used to provide type-specific common control information, such as a sub-type indication or an indication of the presence of certain parameters to be included in the Block ACK Bitmap subfield 376.

In some embodiments, the Block ACK Bitmap subfield 376 is reused to include the control information parameters for the selected control information type.

TABLE 2 shows an example of the values of the Type subfield 396 located in, for example, the first four (4) bits of the Starting Sequence Number Control subfield 394:

TABLE 2

| Value | Type |
|---|---|
| 0 | Coexistence Unavailability |
| 1 | Low-Latency Traffic indication |
| 2 | Multiple Access Points (MAP) Coordination |
| 3 | Multi-Link Feedback |
| 4-15 | Reserved (which can be used for non-primary channel access |
| | (NPCA), dynamic power saving (DPS), Buffer Status Report |
| | (BSR), Link Adaptation, Intermediate FCS (IFCS), and/or the like) |

As shown in FIG. 8, if the Type subfield 396 indicates Multi-Link feedback (that is, having the value of three (3)), then, two (2) or three (3) bits of the eight-bit Type-Specific Common Control Info subfield 398 (denoted a Sub-Type subfield 402) are used to indicate the sub-type of the Multi-Link feedback (for example, Multi-Link adaptation, Multi-link Unavailability, Multi-Link dynamic power save, and/or the like), four (4) bits of the eight-bit Type-Specific Common Control Info subfield 398 (denoted a Number of Links subfield 404) are used to indicate the number of links whose information will be fed back to the AP MLD 302, and two (2) or one (1) bit of the eight-bit Type-Specific Common Control Info subfield 398 (denoted an Other Common Info subfield 406) is reserved or utilized for other common information. TABLE 3 shows some examples of the values of the Sub-Type subfield 402 and the corresponding information.

TABLE 3

| Value | Sub-Type |
|---|---|
| 0 | Multi-Link Coexistence Unavailability |
| 1 | Multi-Link power save |
| 2 | Multi-Link Adaptation |
| 3-7 | Reserved |

In some embodiments, the Sub-Type subfield 402 may be located within the Block ACK Bitmap subfield 376.

Based on the selected control or feedback information type (indicated by the Type subfield 396) and sub-type (indicated by the Sub-Type subfield 402), the Block ACK Bitmap subfield 376 is reused to include the control information parameters for the selected control or feedback information type.

As shown in FIG. 9, in some embodiments, if the selected type 396 is multi-link feedback and selected sub-type 402 is multi-link adaptation, the Block ACK Bitmap subfield 376 is reused to include one or more multi-link adaptation parameters. Based on the number of links whose feedback is reported, the Block ACK Bitmap subfield 376 may comprise one or more sections 420 each corresponding to a link or an affiliated STA 112, wherein each section 420 comprises one or more of the following information:
Link ID 422 (four (4) bits): indicating which link's feedback is reported;
STA Info Length 424 (eight (8) bits): indicating the length of the feedback parameters reported for specific link;
UHR MCS 426 (five (5) bits);
Equal Modulation (EQM) or Unequal Modulation (UNEQM) Flag 428 (one (1) bit);
Unequal Modulation (UNEQM) Pattern 430 (two (2) bits); and
Other Multi-Link (ML) Link Adaptation (LA) information 432 of variable size, such as Number of Spatial Streams (NSS), distributed resource unit (DRU) and/or regular resource unit (RRU) information, Signal-to-Interference-and-Noise-ratio (SINR); Target receive power, RSSI, beamforming training feedback, and/or the like.

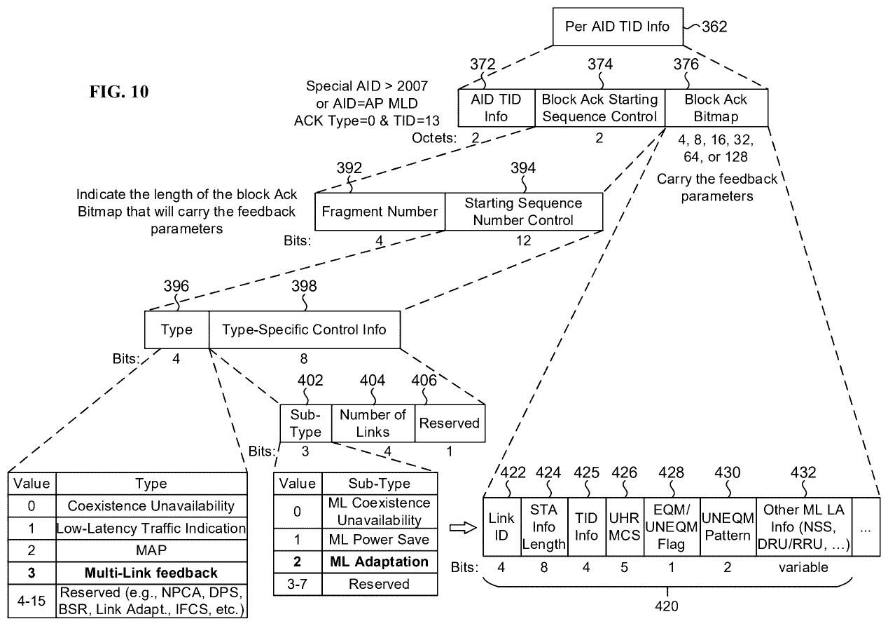

FIG. 10 is a schematic diagram summarizing the details of the structure of the Per AID TID Info field 362.

In above embodiments, the Type subfield 396 uses values zero (0) to three (3) with values four (4) to 15 reserved (which can be used for NPCA, DPS, BSR, Link Adaptation, IFCS, and/or the like); see TABLE 2. In some embodiments, the Type subfield 396 uses values zero (0) to two (2) with values three (3) to 15 reserved (which can be used for NPCA, DPS, BSR, Low-Latency Traffic indication, Link Adaptation, IFCS, and/or the like), as shown in TABLE 4.

TABLE 4

| Value | Type |
|---|---|
| 0 | Coexistence Unavailability |
| 1 | MAP Coordination |
| 2 | Multi-Link Feedback |
| 3-15 | Reserved (which can be used for NPCA, DPS, BSR, Low-Latency |
| | Traffic indication, Link Adaptation, and/or the like) |

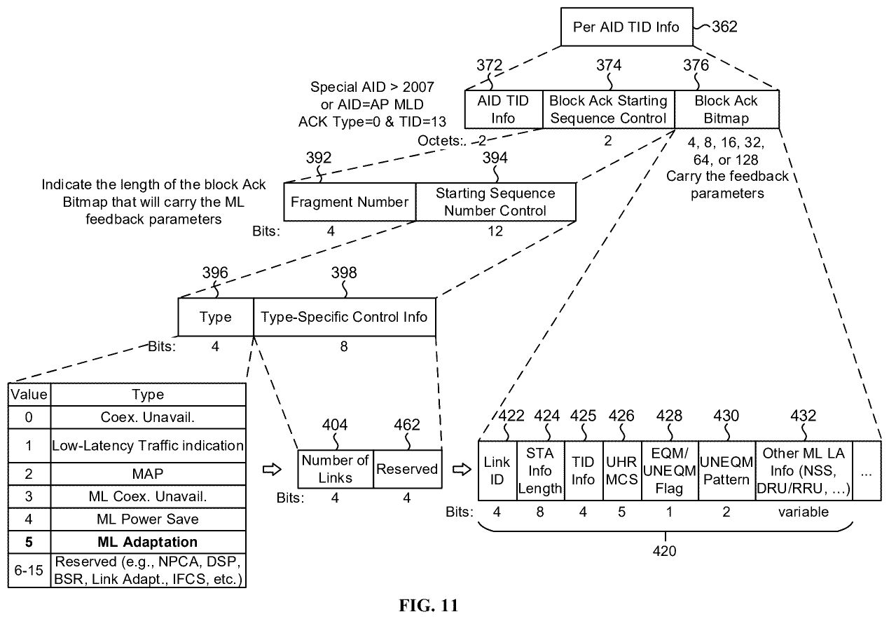

In above embodiments, the Type subfield 396 is used for indicating Coexistence Unavailability, MAP coordination, and Multi-Link Feedback. In some embodiments as shown in FIG. 11, the Type subfield 396 may be used for indicating other types of control or feedback information as well. TABLE 5 shows an example of the values of the Type subfield 396, located in, for example, four (4) bits of the Starting Sequence Number Control subfield 394 (such as the first four (4) bits thereof).

TABLE 5

| Value | Type |
|---|---|
| 0 | Coexistence Unavailability |
| 1 | Low-Latency Traffic indication |
| 2 | MAP Coordination |
| 3 | Multi-Link Coexistence Unavailability |
| 4 | Multi-Link power save |
| 5 | Multi-Link Adaptation |
| 6-15 | Reserved (which can be used for NPCA, DPS, BSR, Link |
| | Adaptation, IFCS, and/or the like |

By using different type values to indicate Multi-Link Adaptation, Multi-link Unavailability, Multi-Link Dynamic Power Save, and/or the like, as indicated in TABLE 5, the eight-bit Type-Specific Common Control Info field 398 may dedicate four (4) bits to indicate the number of links whose information is to be fed back (denoted a Number of Links subfield 404), and four (4) bits are kept reserved or utilized for other common information (denoted a Reserved subfield 462).

Based on the selected type (for example, Multi-Link Adaptation, Multi-Link Unavailability, Multi-Link Dynamic Power Save, or the like), the Block ACK Bitmap subfield 376 is reused to include a Link ID 422 (four (4) bits) for indicating which link's feedback is reported, an STA Info Length 424 (eight (8) bits) for indicating the length of the feedback parameters reported for the specific link, TID Information, and the control or feedback information parameters for the selected control or feedback information type.

For example, as shown in FIG. 11, if the selected type is Multi-Link Adaptation, the Block ACK Bitmap subfield 376 is reused to include the multi-link adaptation parameters for each link or affiliated STA 112 such as:
TID Information 425;
UHR MCS 426;
Equal Modulation (EQM) or Unequal Modulation (UNEQM) Flag 428;
Unequal Modulation (UNEQM) Pattern 430; and
Other ML LA Info 432 of variable size, such as NSS, DRU/RRU information, SINR, Target Receive Power, RSSI, beamforming training feedback, and/or the like.

In a similar embodiment, the Type subfield 396 (located in, for example, the first four (4) bits of the Starting Sequence Number Control subfield 394) is used for indicating various types of control or feedback information as shown in TABLE 6.

TABLE 6

| Value | Type |
|---|---|
| 0 | Coexistence Unavailability |
| 1 | MAP Coordination |
| 2 | Multi-Link Coexistence Unavailability |
| 3 | Multi-Link Power Save |
| 4 | Multi-Link Adaptation |
| 5-15 | Reserved (which can be used for NPCA, DPS, BSR, Low-Latency |
| | Traffic indication, Link Adaptation, IFCS, and/or the like) |

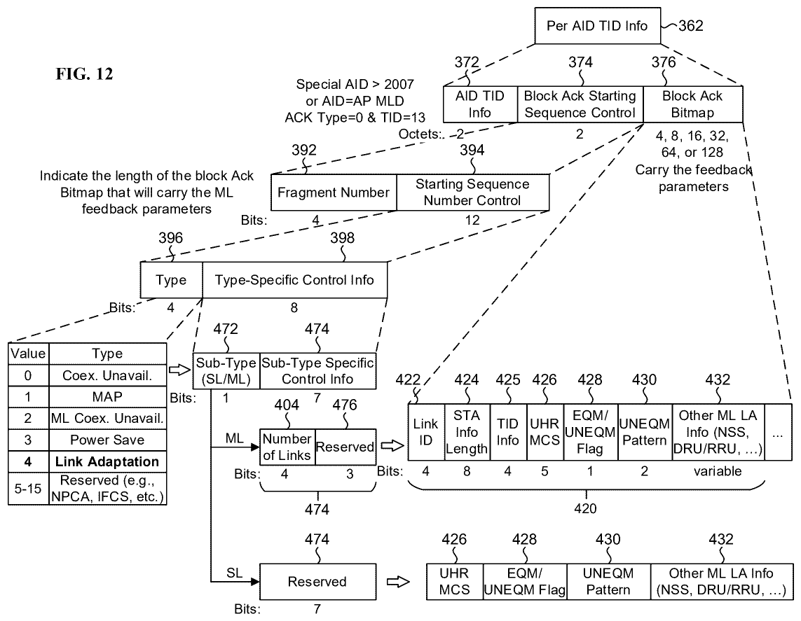

FIG. 12 is a schematic diagram showing the structure of the Per AID TID Info field 362, according to some embodiments of this disclosure. Table 7 shows an example of the values of the Type subfield 396 located in, for example, four (4) bits of the Starting Sequence Number Control subfield 394 (such as the first four (4) bits thereof):

TABLE 7

| Value | Type |
|---|---|
| 0 | Coexistence Unavailability |
| 1 | Low-Latency Traffic indication |
| 2 | MAP Coordination |
| 3 | Power Save |
| 4 | Link Adaptation |
| 5-15 | Reserved (which can be used for NPCA, DPS, BSR, Link |
| | Adaptation, IFCS, and/or the like) |

If the Type subfield 396 has a value between zero (0) and four (4) to indicate Coexistence Unavailability, Low-Latency Traffic Indication, MAP Coordination, Dynamic Power Save, or Link adaptation, as indicated in TABLE 7, the eight-bit Type-Specific Common Control Info field 398 comprises a one-bit Sub-Type field 472 and a seven-bit Sub-Type Specific Control Info field 474.

The value of the Sub-Type field 472 indicates a single-link (SL) or multi-link (ML) operation.

The Sub-Type field 472 may be located within the Block ACK Bitmap subfield 376.

Based on the selected type (for example, Link Adaptation) and the value of the Sub-Type field 472 (that is, the single-link or multi-link operation indication) in the Type-Specific Common Control Info subfield 398, the Block ACK Bitmap subfield 376 is reused to include the single-link or multi-link adaptation information parameters.

For example, a value zero (0) of the Sub-Type field 472 indicates a single link operation and the seven-bit Sub-Type Specific Control Info field 474 may be kept reserved or utilized for other common information. Accordingly, the Block Ack Bitmap subfield 376 may indicate the UHR MCS 426, EQM/UNEQM Flag 428, and UNEQM Pattern 430 of the single link, and may further indicate Other ML LA Info 432 of the single link.

On the other hand, a value one (1) of the Sub-Type field 472 indicates a multi-link operation. Then, four (4) bits of the Sub-Type Specific Control Info field 474 may be used to indicate the number of links' information being fed back (denoted a Number of Links subfield 404), and three (3) bits of the Sub-Type Specific Control Info field 474 may be kept reserved or utilized for other common information (476). Accordingly, the Block Ack Bitmap subfield 376 may indicate the Link ID 422, STA Info Length 424, UHR MCS 426, EQM/UNEQM Flag 428, UNEQM Pattern 430, and optionally Other ML LA Info 432 (for example, RSSI, beamforming training feedback, and/or the like) for each link as described above.

In some embodiments, Multi-Link Reconfiguration Element may be used for Multi-Link Adaptation.

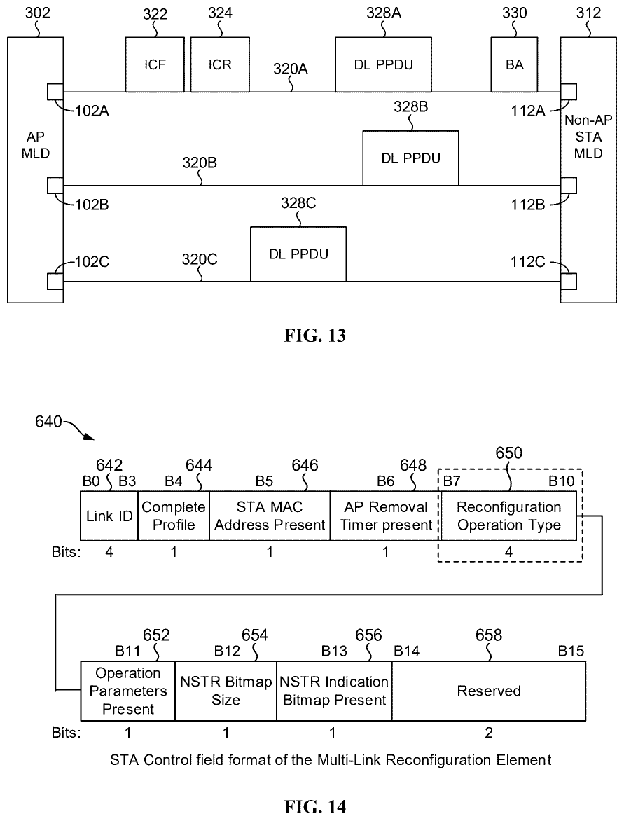

As shown in FIG. 13, the AP MLD 302 sends an Initial Control Frame (ICF) 322 (which acts as a Multi-Link Configuration Request frame) to a non-AP STA MLD 312, requesting its desired link adaptation parameters for each affiliated STA 112. In response, the non-AP STA MLD 312 sends an Initial Control Response (ICR) frame 324 (which acts as a Multi-Link Configuration Response frame) via the link 320A, providing the desired link adaptation parameters for each affiliated STA 112. The downlink transmissions are then scheduled. For example, the AP MLD 302 may transmit a DL PPDU 328A via the link 320A, a DL PPDU 328B via the link 320B, and a DL PPDU 328C via the link 320C. The STA MLD 312 may send a multi-STA block acknowledgement (“BA”, “Block ACK”, or “multi-STA Block ACK”) frame 330 via, for example, link 320A after receiving the DL PPDUs 328A to 328C.

In some embodiments, the link adaptation information for each affiliated STA 112 may be included within the Multi-Link Reconfiguration Element of a Link (Re) configuration (where “(re) configuration” represents “configuration” or “reconfiguration”) Request frame, a Link (Re) configuration Response frame, or a Link (Re) configuration notify action frame, as discussed below. Additionally, the non-AP STA MLD 312 may send unsolicited Multi-Link adaptation information by transmitting a Multi-Link Configuration Notify frame.

FIG. 14 is a schematic diagram showing the structure of the STA Control field 640 of the Multi-Link Reconfiguration Element, which comprises a four-bit Link ID subfield 642, a one-bit Complete Profile subfield 644, a one-bit STA MAC Address Present subfield 646, a one-bit AP Removal Timer present subfield 648, a four-bit Reconfiguration Operation Type subfield 650, a one-bit Operation Parameters Present subfield 652, a one-bit NSTR Bitmap Size subfield 654, a one-bit NSTR Indication Bitmap present subfield 656, and a two-bit reserved subfield 658 (bits B14 and B15). In some embodiments, the Reconfiguration Operation Type subfield 650 may take the values shown in TABLE 8, wherein one of the conventionally reserved values of the Reconfiguration Operation Type subfield 650 (such as value 5) may be used in these embodiments for indicating that this Multi-Link Reconfiguration Element is for Link Adaptation feedback.

TABLE 8

| Value | Name |
|---|---|
| 0 | AP Removal |
| 1 | Operation Parameter Update |
| 2 | Add Link |
| 3 | Delete Link |
| 4 | NSTR Status Update |
| 5 | Feedback |
| 6-15 | Reserved |

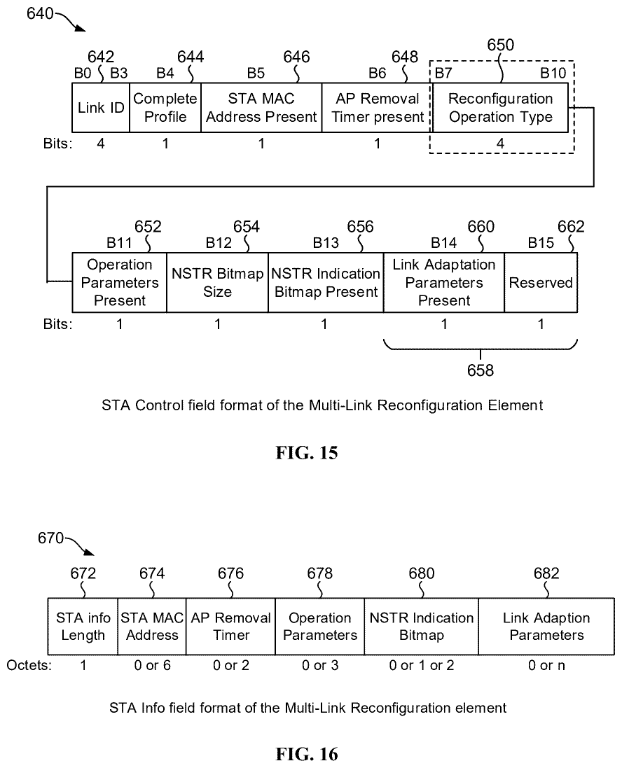

In some embodiments, Link Adaptation Parameters Present for each affiliated STA can be included in STA Control field 640 of the Multi-Link Reconfiguration Element by utilizing any reserved bit of the two-bit reserved subfield 658 (B14-B15), such as B14, of the STA Control field 640 of the Multi-Link Reconfiguration Element, as shown in FIG. 15.

FIG. 16 is a schematic diagram showing the structure of the STA Info field 670 of the Multi-Link Reconfiguration Element, which comprises a one-byte STA info Length subfield 672, an optional six-byte STA MAC Address subfield 674, an optional two-byte AP Removal Timer subfield 676, an optional three-byte Operation Parameters subfield 678, an optional one- or two-byte NSTR Indication Bitmap subfield 680, and a n-byte (n being an integer) Link Adaption Parameters subfield 682 for storing the link adaptation parameters, when the value of the Link Adaptation Parameters Present subfield 660 is set to one (1).

For example, the Link Adaptation Parameters subfield 682 may comprise one or more of the following information:
Link ID (four (4) bits): indicating which link's feedback is reported;
STA Info Length (eight (8) bits): indicating the length of the feedback parameters reported for specific link;
TID Information;
UHR MCS (5 bits);
Equal or Unequal Modulation Flag (one (1) bit);
Unequal Modulation Pattern (two (2) bits);
Number of Spatial Streams (NSS);
Signal-to-Interference-and-Noise-ratio (SINR);
DRU/RRU information; and optionally
Other Information (for example, RSSI, Beamforming training feedback, and/or the like).

For instance, The AP MLD 302 sends a Multi-Link Configuration Request frame to a non-AP STA MLD 312, requesting its desired link adaptation parameters. Within this Multi-Link Configuration Request, the AP MLD 302 includes a Multi-Link Reconfiguration Element with the value of the Reconfiguration Operation Type subfield 650 of the STA Control field 640 is set to, for example, five (5), to indicate that link adaptation feedback is solicited.

In response, the non-AP STA MLD 312 sends a Multi-Link Configuration Response frame, providing the desired link adaptation parameters for each affiliated STA 112 within the STA Info field 670 of the Multi-Link Reconfiguration Element, carried by the Multi-Link Configuration Response frame.

Those skilled in the art will appreciate that, in various embodiments, the location of the subfields within the Block Ack Starting Sequence Control field and Block Ack Bitmap field may vary.

In above description, DL transmission is described as an example for leveraging multi-link adaptation in MLOs. However, those skilled in the art will appreciate that, in various embodiments, multi-link adaptation may also be employed for UL transmission in MLOs.

The methods disclosed herein have various advantages and technical benefits.

For example, the methods disclosed herein provide multi-link adaptation for transmission optimization, which enables MLDs 302 and 312 to dynamically adjust transmission parameters (such as modulation, data rates, power levels, Beamforming training feedback, and/or the like) across multiple frequency bands, thereby increasing or even optimizing throughput, and reducing or even minimizing latency. The methods disclosed herein provide enhanced transmission scheduling and conflict resolution, which improves transmission efficiency by managing transmission opportunities (TXOP) across multiple links, reducing conflicts and retransmissions, thus enhancing overall network performance. Moreover, the methods disclosed herein provide scalability and flexibility across frequency bands, which ensures mechanisms are scalable across both lower-frequency bands (such as sub-7.25 GHz bands) and higher-frequency bands (such as 42 GHz to 71 GHz), supporting future WI-FI® developments and improving performance across diverse environments.

C. ACRONYMS, ABBREVIATIONS,
AND DEFINITION OF SOME TERMS

| Full Name | Acronym/Abbreviation/Initialism |
|---|---|
| Access Category | AC |
| Access Point | AP |
| AID | Associated Identifier |
| Basic Service Set | BSS |
| Block Acknowledgement | BA |
| Block Acknowledgement Request | BAR |
| Buffer Status Report Poll | BSRP |
| Clear-to-Send | CTS |
| Coordinated Beamforming | Co-BF |
| Coordinated Spatial Reuse | Co-SR |
| Coordinated Time Division Multiple | Co-TDMA |
| Access | |
| Coordinated Orthogonal Frequency | Co-OFDMA |
| Division Multiple Access | |
| Coordinated restricted Target | Co-r-TWT |
| Wake-up Time | |
| Downlink | DL |
| Enhanced Distributed Channel | EDCA |
| Access | |
| Initial Control Frame | ICF |
| Initial Control Response | ICR |
| Link Adaptation | LA |
| Multi-AP | MAP |
| Multi-AP Coordination | MAPC |
| Multi-Stations Block | Multi-STA BA |
| Acknowledgement | |
| Multi-User Block Acknowledgement | MU-BAR |
| Request | |
| Multi-User Request-to-Send | MU-RTS |
| Multi-Link | ML |
| Multi-Link Operation | MLO |
| Non-Primary Channel Access | NPCA |
| Overlapping Basic Service Set | OBSS |
| Physical | PHY |
| Reception | RX |
| Signal-to-Interference-plus-Noise- | SINR |
| Ratio | |
| Service Period | SP |
| Station | STA |
| Target Beacon Transmission Time | TBTT |
| Traffic Identifier | TID |
| Transmission | TX |
| Transmission Opportunity | TXOP |
| To Be Defined | TBD |
| Ultra-High Reliability | UHR |
| Uplink | UL |
| Wireless LAN | WLAN |

Herein, the terms “field” and “subfield” are used for describing frame structures, wherein a field may comprise a plurality of subfields, and a subfield may comprise a plurality of other subfields. However, those skilled in the art will appreciate that terms “field” and “subfield” may be used interchangeably. For example, it may be described that a field may comprise a plurality of other fields. Although not used very often, it may be described that a subfield may comprise a plurality of fields. In all these descriptions, those skilled in the art will understand that a field or a subfield is a section or segment of information, which may be partitioned into a plurality of (smaller) sections or segments of information. While above description may include expressions such as “a frame includes a field, and the field further includes a plurality of subfields”, or the like, those skilled in the art will readily understand that such expressions are equivalent to the expressions such as “the frame includes the plurality of subfields”, or the like, where the term “field” may be ignored.

The terms “first”, “second”, and “third” are used for descriptive purposes only, and are not to be construed as indicating or implying the relative importance or implicitly indicating the number of indicated technical features. Thus, a feature defined with “first”, “second”, or “third” may explicitly or implicitly include one or more of the features.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example implementation, should be understood to mean that the value, condition or characteristic is defined within tolerances that are acceptable for the proper operation of the example implementation for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different implementations of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” may indicate an “or” relationship between associated objects, or may indicate an “and/or” relationship thereof, depending on the context. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C.

In addition, unless otherwise specified, ordinal numbers such as “first” and “second” in implementations of this application are used to distinguish between a plurality of objects, and are not used to limit a sequence, a time sequence, priorities, or importance of the plurality of objects.

Herein, the term “preconfigured” (for example, a “preconfigured” item such as a “preconfigured” parameter) refers to an item configured by a suitable apparatus before a certain even occurs.

Although in above examples, the adaptive information retrieval method is performed by the computer network system 100, in some embodiments, no computer network system 100 is required, and the methods disclosed herein is performed by a single computing device 102 or 104.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

A person skilled in the art should understand that implementations of this application may be provided as a method, an apparatus (or system), computer-readable storage medium, or a computer program product. Therefore, this application may use a form of a hardware-only implementation, a software-only implementation, or an implementation with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

It is clear that a person skilled in the art can make various modifications and variations to this application without departing from the scope of this disclosure. More specifically, although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. This disclosure is intended to cover these modifications and variations of this application provided that they fall within the scope of protection defined by the following claims and their equivalent technologies.

1. A communication method performed by a first multi-link device (MLD), the method comprising:
transmitting or receiving a first frame indicating a plurality of communication parameters of a plurality of links; and
receiving or transmitting a plurality of data frames via the plurality of links using at least one of the plurality of communication parameters.

2. The method of claim 1, wherein the first frame is a multi-STA block acknowledgement (multi-STA Block ACK) frame conveying control or feedback information including the plurality of communication parameters, or the first frame comprises a Multi-Link Reconfiguration Element conveying the plurality of communication parameters.

3. The method of claim 2, wherein the first frame is the multi-STA Block ACK frame;
wherein the first frame comprises a Per Associated Identifier (AID) Traffic Identifier (TID) Info field;
wherein the Per AID TID info field comprises a Type field and a Block Ack Bitmap field;
wherein the Type field is for indicating that the type of the control or feedback information is multi-link feedback, or indicating that the type of the control or feedback information is multi-link adaptation, or indicating that the type of the control or feedback information is link adaptation; and
wherein the Block Ack Bitmap field is for conveying the control or feedback information including the plurality of communication parameters.

4. The method of claim 3, wherein the Per AID TID info field further comprises a Sub-Type field; and
wherein the Type field indicates that the type of the control or feedback information is the multi-link feedback and the Sub-Type field indicates that the type of multi-link feedback is multi-link adaptation, or the Type field indicates that the type of the control or feedback information is the link adaptation and the Sub-Type field indicates that the link adaptation is single-link adaptation or multi-link adaptation.

5. The method of claim 2, wherein the first frame comprises the Multi-Link Reconfiguration Element;
wherein the Multi-Link Reconfiguration Element comprises a STA Control field and a STA Info field;
wherein the STA Control field comprises a Reconfiguration Operation Type field having a value indicating that the first frame is a link adaptation feedback, and a Link Adaptation Parameters Present field; and
wherein the STA Info field comprises the plurality of communication parameters.

6. The method of claim 1, wherein the plurality of communication parameters comprise:
a modulation and coding scheme (MCS) of each of the plurality of links;
an indication of equal modulation (EQM) or unequal modulation (UNEQM) of each of the plurality of links;
an UNEQM pattern of each of the plurality of links;
a number of spatial streams (NSS) of each of the plurality of links;
a signal-to-interference-and-noise-ratio (SINR) of each of the plurality of links;
a target receive power of each of the plurality of links;
a resource unit (RU) information of each of the plurality of links; or
a combination thereof.

7. A communication apparatus comprising:
one or more processors functionally coupled to one or more non-transitory computer-readable storage media storing computer-executable instructions;
wherein the instructions, when executed, cause the one or more processors to perform actions comprising:
transmitting or receiving a first frame indicating a plurality of communication parameters of a plurality of links; and
receiving or transmitting a plurality of data frames via the plurality of links using at least one of the plurality of communication parameters.

8. The communication apparatus of claim 7, wherein the first frame is a multi-STA block acknowledgement (multi-STA Block ACK) frame conveying control or feedback information including the plurality of communication parameters, or the first frame comprises a Multi-Link Reconfiguration Element conveying the plurality of communication parameters.

9. The communication apparatus of claim 8, wherein the first frame is the multi-STA Block ACK frame;
wherein the first frame comprises a Per Associated Identifier (AID) Traffic Identifier (TID) Info field;
wherein the Per AID TID info field comprises a Type field and a Block Ack Bitmap field;
wherein the Type field is for indicating that the type of the control or feedback information is multi-link feedback, or indicating that the type of the control or feedback information is multi-link adaptation, or indicating that the type of the control or feedback information is link adaptation; and
wherein the Block Ack Bitmap field is for conveying the control or feedback information including the plurality of communication parameters.

10. The communication apparatus of claim 9, wherein the Per AID TID info field further comprises a Sub-Type field; and
wherein the Type field indicates that the type of the control or feedback information is the multi-link feedback and the Sub-Type field indicates that the type of multi-link feedback is multi-link adaptation, or the Type field indicates that the type of the control or feedback information is the link adaptation and the Sub-Type field indicates that the link adaptation is single-link adaptation or multi-link adaptation.

11. The communication apparatus of claim 8, wherein the Multi-Link Reconfiguration Element comprises a STA Control field and a STA Info field;
wherein the STA Control field comprises a Reconfiguration Operation Type field having a value indicating that the first frame is a link adaptation feedback, and a Link Adaptation Parameters Present field; and
wherein the STA Info field comprises the plurality of communication parameters.

12. The communication apparatus of claim 7, wherein the plurality of communication parameters comprise:
a modulation and coding scheme (MCS) of each of the plurality of links;
an indication of equal modulation (EQM) or unequal modulation (UNEQM) of each of the plurality of links;
an UNEQM pattern of each of the plurality of links;
a number of spatial streams (NSS) of each of the plurality of links;
a signal-to-interference-and-noise-ratio (SINR) of each of the plurality of links;
a target receive power of each of the plurality of links;
a resource unit (RU) information of each of the plurality of links; or
a combination thereof.

13. One or more non-transitory computer-readable storage media comprising computer-executable instructions, wherein the instructions, when executed, cause one or more processors to perform actions comprising:
transmitting or receiving a first frame indicating a plurality of communication parameters of a plurality of links; and
receiving or transmitting a plurality of data frames via the plurality of links using at least one of the plurality of communication parameters.

14. The one or more non-transitory computer-readable storage media of claim 13, wherein the plurality of communication parameters comprise:
a modulation and coding scheme (MCS) of each of the plurality of links;
an indication of equal modulation (EQM) or unequal modulation (UNEQM) of each of the plurality of links;
an UNEQM pattern of each of the plurality of links;
a number of spatial streams (NSS) of each of the plurality of links;
a signal-to-interference-and-noise-ratio (SINR) of each of the plurality of links;
a target receive power of each of the plurality of links;
a resource unit (RU) information of each of the plurality of links; or
a combination thereof.

15. The one or more non-transitory computer-readable storage media of claim 13, wherein the first frame is transmitted via one of the plurality of links or a sub-7.25 gigahertz (GHz) frequency band.

16. The one or more non-transitory computer-readable storage media of claim 13, wherein the first frame is a multi-STA block acknowledgement (multi-STA Block ACK) frame conveying control or feedback information including the plurality of communication parameters, or the first frame comprises a Multi-Link Reconfiguration Element conveying the plurality of communication parameters.

17. The one or more non-transitory computer-readable storage media of claim 16, wherein the first frame is the multi-STA Block ACK frame; and
wherein the first frame comprises a Per Associated Identifier (AID) Traffic Identifier (TID) Info field indicating the plurality of communication parameters.

18. The one or more non-transitory computer-readable storage media of claim 17, wherein the Per AID TID info field comprises an AID11 field having a value greater than 2007, an acknowledge (ACK) Type field, and a TID field; and
wherein values of the ACK Type field and the TID field indicate that the Per AID TID Info field is for conveying the control or feedback information.

19. The one or more non-transitory computer-readable storage media of claim 17, wherein the Per AID TID info field comprises a Type field indicating that the type of the control or feedback information is multi-link feedback, or indicating that the type of the control or feedback information is multi-link adaptation, or indicating that the type of the control or feedback information is link adaptation.

20. The one or more non-transitory computer-readable storage media of claim 19, wherein the Per AID TID info field comprises a Sub-Type field; and
wherein the Type field indicates that the type of the control or feedback information is the multi-link feedback and the Sub-Type field indicates that the type of multi-link feedback is multi-link adaptation, or the Type field indicates that the type of the control or feedback information is the link adaptation and the Sub-Type field indicates that the link adaptation is single-link adaptation or multi-link adaptation.
